(19) United States
(12) Patent Application Publication
(10) Pub. No.: US 2012/0236559 A1
(43) Pub. Date: Sep. 20, 2012

(54) Lighting Module

(76) Inventors: Peter Sachsenweger, Zeitlarn (DE); Simon Schwalenberg, Donaustauf (DE)

(21) Appl. No.: 13/513,846

(22) PCT Filed: Nov. 26, 2010
(86) PCT No.: PCT/EP2010/068274

§ 371 Date: Jun. 4, 2012

(30) Foreign Application Priority Data
Dec. 4, 2009 (DE) 10 2009 047 487.0

(51) Int. Cl. F21V 8/00

(52) U.S. Cl. 362/235

(57) ABSTRACT

A lighting module (1), comprising a circuit board (2) equipped with at least one light source:, (3) and a hollow light guide element (4; 31; 33) which laterally surrounds the circumference of the at least one light source (3) and extends forward beyond the at least one light source (3), wherein an inner face (4a; 32; 34) of the light guide element (4; 31; 33) is at least partially reflective and a front-side opening of the light guide element (4; 31; 33) corresponds to a light emission opening (L) of the lighting module (1).

The invention relates to a lighting module comprising a circuit board which is equipped with at least one light source, in particular a light-emitting diode, on the front face thereof.

Compact lighting modules based on light-emitting diodes require circuit boards, on which are mounted both the actual light-emitting diodes (for example individual light-emitting diodes) and also electronic components for operating and regulating the light-emitting diodes and thus the light output. Downstream optical systems (for example lenses or reflectors) must be positioned at a disadvantageous distance from the actual light-emitting diodes on account of the typically greater component heights and required electrical separation distances, which results in poor incoupling efficiency into the optical systems.

DE 10 2007 015 475 A1 discloses a multiple light-emitting diode module having a plurality of light-emitting diodes with at least a first and a second light-emitting diode and a light-mixing element which has a hollow space and/or a light-mixing rod, whereby the light-mixing element has a reflective surface area and a light-emitting surface area, electromagnetic radiation emitted by the plurality of light-emitting diodes during operation is reflected at the reflective surface area and is mixed in this situation, and the reflected and mixed radiation is outcoupled through the light-emitting surface area. This multiple light-emitting diode module has the disadvantage that complex and cost-intensive constructions having a plurality of connected circuit boards are required, which are also difficult to cool.

The object of the present invention is to at least partially avoid the disadvantages of the prior art and in particular to provide a simply constructed lighting module which can be contacted optically in a simple and effective manner.

This object is achieved in accordance with the features of the independent claims. Preferred embodiments are set down in particular in the dependent claims.

The object is achieved by a lighting module comprising a circuit board which is equipped on the front face thereof with at least one light source, and also a hollow light guide element which laterally surrounds the circumference of the at least one light source and extends forward beyond the at least one light source, whereby an inner face of the light guide element is at least partially reflective and a front-side opening of the light guide element corresponds to a light emission opening of the lighting module.

The light from the light source(s) is guided by means of the light guide element, which acts as a “light channel”, from the plane of the light source(s) to a higher plane of the lighting module, namely to the plane of the light emission opening. This means that it is also possible to bridge a mounting space required for electronic components (capacitors, resistors, driver modules etc.) and to define a new, higher light emission plane. Attachment elements (optical or optically active elements etc.) can then be brought as close as desired to the light emission opening as the new light-emitting plane, which means that incoupling losses are avoided.

The fact that the light guide element laterally surrounds the circumference of the at least one light source also includes the case in which the light guide element is displaced forwards with respect to the light source, in other words there can be a (for the most part small) vertical separation distance to the at least one light source (more precisely: the emitter surface area thereof). In order to prevent light losses, it is however preferred if the light guide element is not displaced forwards with respect to the light source.

By preference, the at least one light source comprises at least one light-emitting diode. If a plurality of light-emitting diodes is present, these can emit in the same color or in different colors. A color can be monochromatic (for example red, green, blue etc.) or multichromatic (for example white). The light output by the at least one light-emitting diode can also be an infrared light (IR LED) or an ultraviolet light (UV LED). A plurality of light-emitting diodes can generate a mixed light; for example a white mixed light. The at least one light-emitting diode can contain at least one wavelength converting fluorescent substance (conversion LED). The at least one light-emitting diode can be present in the form of at least one individually housed light-emitting diode or in the form of at least one LED chip. A plurality of LED chips can be mounted on a common substrate (“submount”). The at least one light-emitting diode can be equipped with at least one separate and/or common optical system for beam guidance, for example at least one Fresnel lens, collimator, and so forth. Instead of or in addition to inorganic light-emitting diodes, for example based on InGaN or AlInGaP, organic LEDs (OLEDs, for example polymer OLEDs) can in general also be employed. Diode lasers for example can also be used. Alternatively, the at least one light source can for example have at least one diode laser.

It is an embodiment that a plane of the light emission opening is parallel to a plane of the at least one light source. This means that it is possible to raise the “light interface” simply from the plane of the light source(s), in which the latter is/are disposed, forwards in the direction of the main output direction or optical axis. Alternatively, the plane of the light emission opening can be disposed angled to the plane of the at least one light source.

It is another embodiment that the light guide element has an essentially hollow cylindrical basic form. This form is particularly simple to produce and to assemble.

It is furthermore an embodiment that the light guide element consists of an electrically nonconducting or dielectric material. This means that electrically conducting attachment elements (for example aluminum reflectors) can be isolated from the electrically conducting parts on the circuit board, which facilitates the observance of air gaps and creepage distances. To this end, the light guide element can consist for example of a plastic, for example PC, PMMA, COC, COP, or of glass.

It is also an embodiment that the lighting module has at least one receiving means for receiving an attachment element by way of the light emission opening. This receiving means can be used in particular for adjusting the position of the attachment element with respect to the light emission opening. The receiving means can in particular have a (‘standardized’) position, which is also defined for differing lighting modules, with respect to the light emission opening in order to thus be able to create a design for attachment elements which is essentially independent of a design for such lighting modules (without the attachment element).

It is a particular embodiment that the receiving means is designed as a fastening interface which enables the attachment element when suitably designed to be fastened on the lighting module in a defined position with respect to the light emission opening. The fastening interface can for example be a part of a bayonet lock, a screw lock (a twist lock in general), a push-fit lock etc.

It is another embodiment that the lighting module has a cover for at least some of the electronic components disposed on the front face of the circuit board, whereby a front face of the cover essentially lies in the plane of the light emission opening. This means that it is possible in particular to achieve an essentially flat front-side surface of the lighting module, in which the light emission opening is essentially incorporated in flush fashion.

It is a further embodiment that the light guide element is laterally surrounded at least in sections of the circumference by a ring-shaped cover for at least some of the electronic components disposed on the front face of the circuit board. Thus it is possible to spatially separate in a particularly compact and easy to assemble manner the, in particular central, for example circular, region for the at least one light source from a region, in particular ring-shaped and circular, surrounding the latter.

It is a development that the light guide element affords a direct access to the at least one light source through the light emission opening, in other words for example has no cover. It is thereby possible to minimize a light loss between the at least one light source and the light emission opening.

It is another development that the light guide element has a (reflective) inner face which widens towards the front. The inner face can for example have an essentially truncated conical contour. This yields the advantage that the output of the light beam emitted by the at least one light source can be collimated, which produces a narrower angular distribution. It has proved advantageous that an angulation (also referred to as “draft angle”) a lies in a range between 1° and 10°, in particular between 1° and 5° (including the end values).

It is an alternative embodiment that the light guide element has an inner face which narrows towards the front, for example with an inverse truncated conical contour. This yields the advantage that the output of the light beam emitted by the at least one light source can be decollimated, which produces a narrower angular distribution. It has proved advantageous that the angulation a lies in a range between −1° and −10°, in particular between −1° and −5° (including the end values).

It is another embodiment that the inner face of the light guide element has an optically active surface structure. It is thereby possible in particular to achieve a light mixture, for example with regard to a brightness and/or a color of the light emitted by the at least one light source, in a simple and compact manner.

It is a development that the surface structure has a wave structure or is formed by means of such a wave structure. The wave structure can for example have a sinusoidal wave structure, but also a form based on splines or even a free form. It has proved advantageous that a so-called “peak-to-valley” angle β of the wave structure lies in a range [30°; 60°]. Alternatively, other general height structures can also be used, for example in the form of a circumferential zigzag pattern.

It is another development that the surface structure has a roughened surface, for example an isotropically or anisotropically scattering surface. This yields the advantage that a light mixture which is directional with respect to an azimuthal and/or polar angle can be achieved.

The reflective surface or inner face of the light guide element can also be colored in its entirety or partially in one color or multiple colors, whereby a color of the light output can be colored.

The reflective region of the light guide element, for example the inner face thereof, can in general be designed as specular or diffusely reflective, for example by means of a coating or a film. The coating or the film can for example at least comprise a layer of aluminum, silver, a dielectric coating and/or for example also comprise barium sulfate. The reflective surface of the light guide element, for example the inner face thereof, can also have an optical film, for example a highly reflective mirror film or diffuser film (so-called “brightness enhancement film”, BEF), or a coating of such a type, which serves to increase efficiency.

In the following figures, the invention will be described schematically in detail with reference to exemplary embodiments. In this situation, the same elements or elements having the same function can be provided with the same reference characters for the sake of clarity.

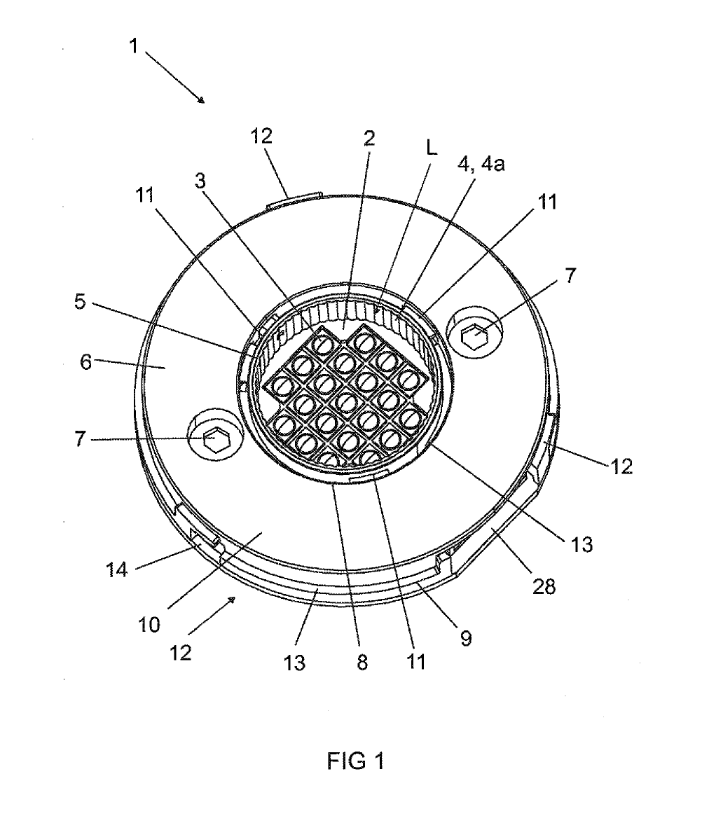

FIG. 1 shows an oblique view from the front or above of a lighting module according to the invention without attachment element;

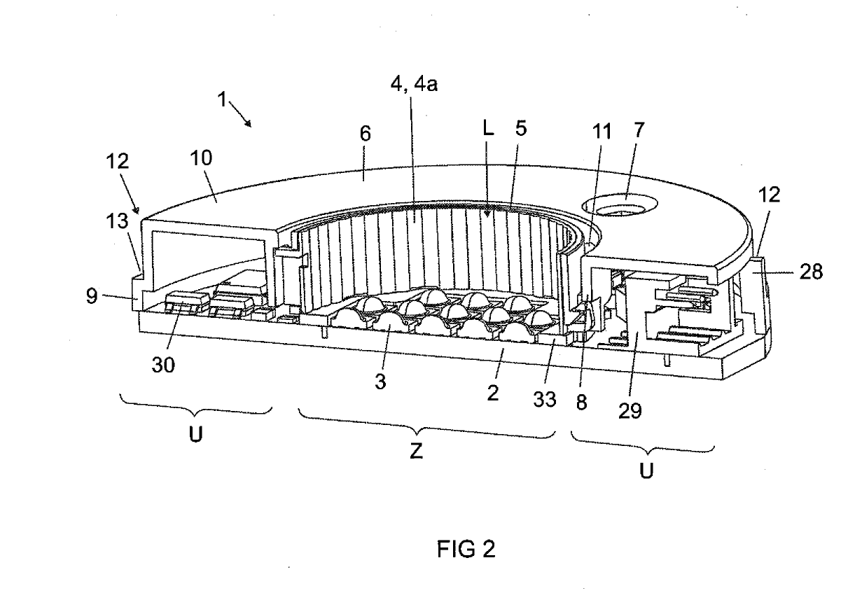

FIG. 2 shows an oblique sectional view of the lighting module;

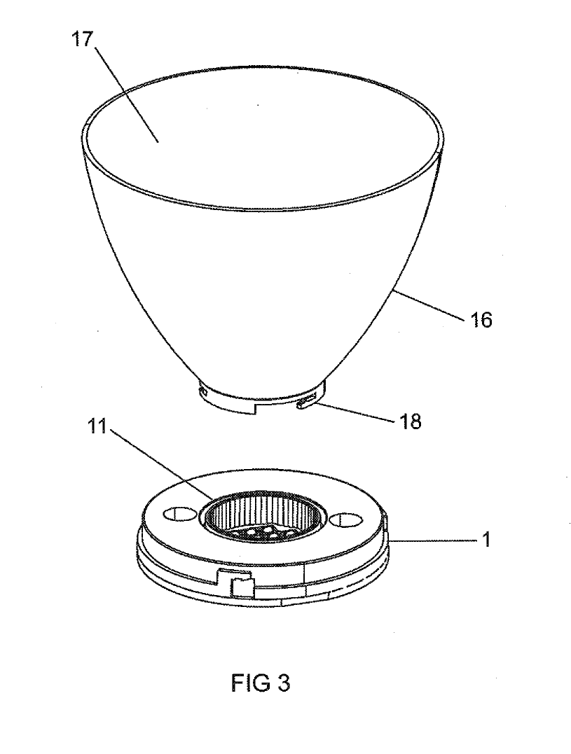

FIG. 3 shows an oblique view of the lighting module with an attachment element floating above it;

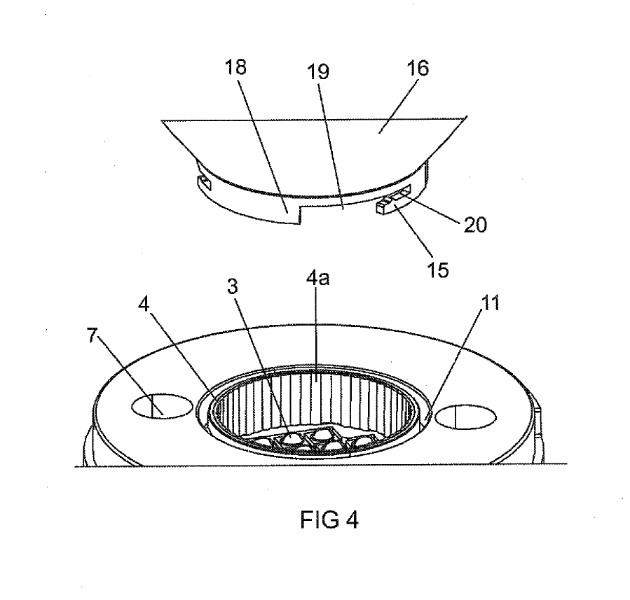

FIG. 4 shows an enlarged view of part of the lighting module with the attachment element floating above it in a region of an internal bayonet socket;

FIG. 5 shows an oblique view from the front of a group of light-emitting diodes of the lighting module in a further arrangement;

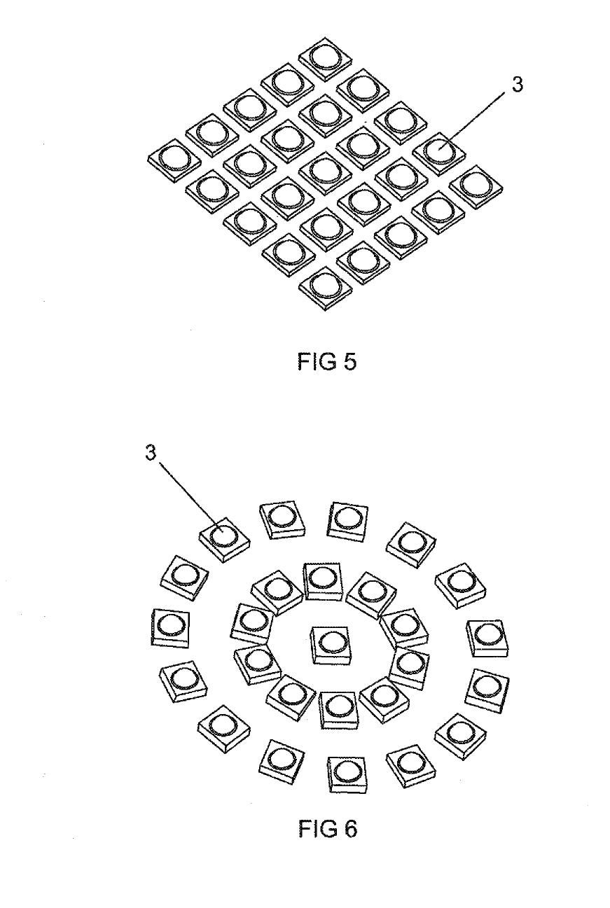

FIG. 6 shows an oblique view from the front of a group of light-emitting diodes of the lighting module in another arrangement;

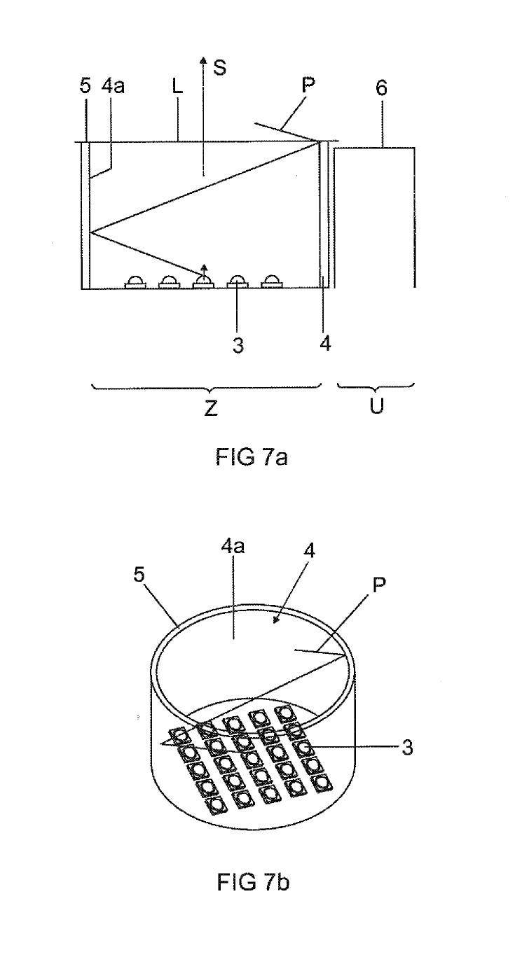

FIG. 7a shows a sectional side view of a light guide element surrounding light-emitting diodes, with a possible light path drawn in;

FIG. 7b shows an oblique view from the front of the light guide element from FIG. 7a surrounding the light-emitting diodes, with the possible light path;

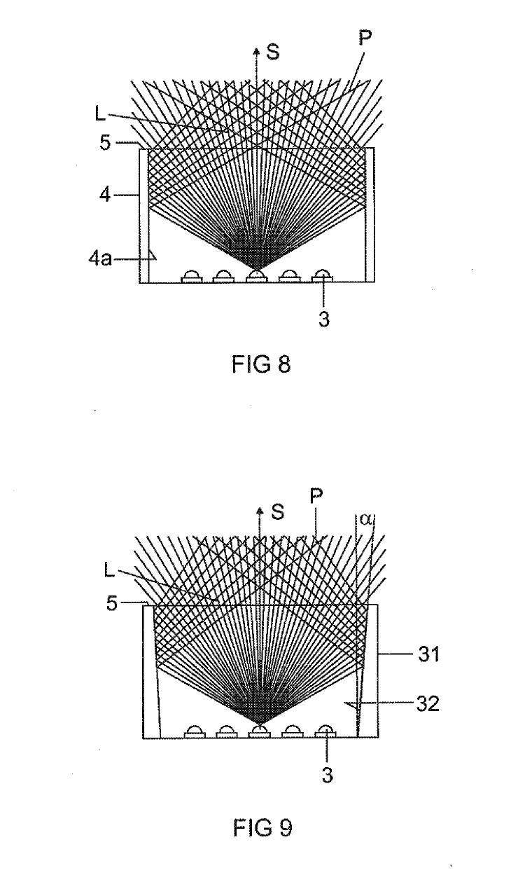

FIG. 8 shows a sectional side view of the light guide element from FIG. 7a surrounding the light-emitting diodes, with a plurality of possible light paths;

FIG. 9 shows a sectional side view of a light guide element according to a further embodiment surrounding the light-emitting diodes, with a plurality of possible light paths;

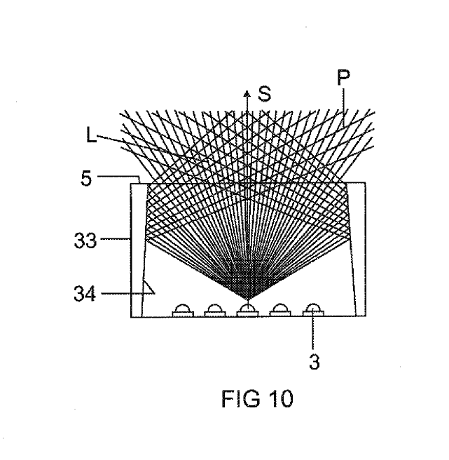

FIG. 10 shows a sectional side view of a light guide element according to another embodiment surrounding the light-emitting diodes, with a plurality of possible light paths;

FIG. 11 shows an oblique view from the front of the light guide element from FIG. 1;

FIG. 12 shows a top view of the light guide element from FIG. 11; and

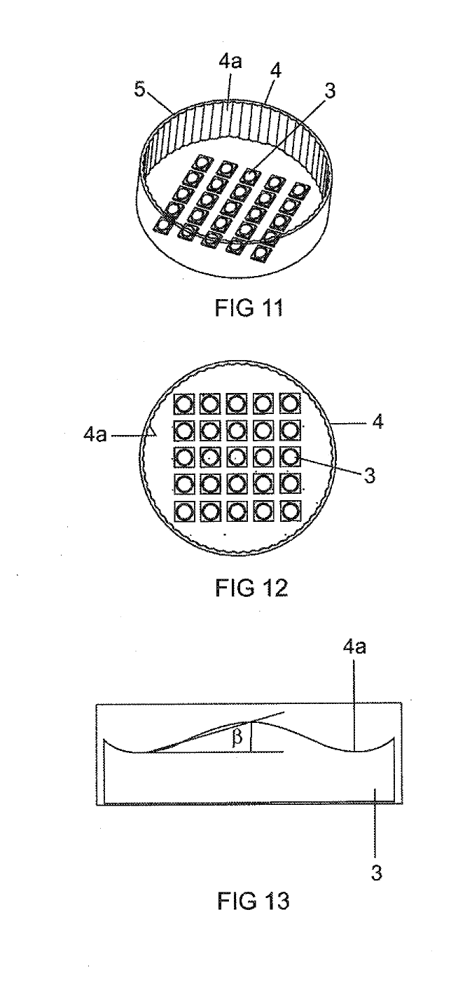

FIG. 13 shows a part of the light guide element from FIG. 12.

FIG. 1 shows an oblique view from the front or above of a lighting module 1 according to the invention without attachment element. FIG. 2 shows an oblique sectional view of the lighting module.

The lighting module 1 comprises an essentially disk-shaped circuit board 2 which is equipped in a central region Z of a front face with a plurality of light sources in the form of light-emitting diodes 3. The light-emitting diodes 3 can emit light of the same type or may differ with regard to their brightness and/or color. An essentially hollow cylindrical light guide element 4, common to the light-emitting diodes 3 arranged in a cruciform matrix pattern, laterally surrounds the circumference of the light-emitting diodes 3. A front edge 5 of the light guide element 4 delimits and surrounds an essentially circular disk-shaped light emission opening L. In other words, the light emission opening L corresponds to a front-side opening of the light guide element 4. The inner face 4a, which stands straight or parallel as a result of the hollow cylindrical shape and which is designed to be reflective, has the advantage that an angular distribution of the light beam output by the light sources 3 is rotationally symmetrical.

The circuit board 2 is furthermore equipped in a surrounding region U surrounding the central region Z with further electronic components 30, for example with resistors, capacitors and/or logic modules, for example as part of a driver logic module. The further electronic components 30 located in the surrounding region U are overarched by a ring-shaped cover 6 which is supported on the circuit board 2 by a rear-side edge. The ring-shaped cover 6 is fastened by means of two screws 7 and has a connector feedthrough 28 for electrically contacting a connector 29 likewise mounted on the circuit board 4.

The ring-shaped cover 6 has an essentially cylindrical inner wall 8 (corresponding to an inner lateral surface or inner side wall) which concentrically laterally surrounds the central region Z of the lighting module 1 and thus also the light guide element 4. The ring-shaped cover 6 furthermore has an essentially cylindrical outer wall 9 (corresponding to an outer lateral surface or outer side wall). The outer wall 9 is the same height as the inner wall 8. The inner wall 8 and the outer wall 9 can be supported by their rear-side edge on the circuit board 2 and can be connected at their front-side edge by a top wall 10. The top wall 10 is designed here as a circular ring-shaped flat plate. The light guide element 4 and the ring-shaped cover 6 can be separate components, components connected to one another or integrated with one another.

A first fastening interface in the form of an internal bayonet socket 11 is integrated into the inner wall 8 of the ring-shaped cover 6. A second fastening interface in the form of an external bayonet socket 12 is integrated into the outer wall 9 of the ring-shaped cover 6. Each of the bayonet sockets 11 and 12 has three longitudinal slots 13, each of which is accessible from the front, at the end of which a short transverse slot 14 is positioned at right angle. The longitudinal slot 13 has a horizontal floor which can also be used as a position adjustment aid. An attachment element can have a bayonet fitting matching one of the bayonet sockets 11 or 12, which can be inserted into the longitudinal slot 13 and fastened by rotating into the transverse slot 14. For locking the bayonet socket and the bayonet fitting the transverse slot 14 has a locking pin, over which a corresponding locking (counter—) pin 15 of the bayonet fitting can be pushed.

The light emission opening L and the inner wall 8 and the outer wall 9 terminate at the same height. This means that the attachment element can be brought into contact with the ring-shaped cover 6 in a simple manner. In other words, the lighting module 1 has an essentially flat front face at which the ring-shaped cover 6 and the light guide element 4 terminate flush.

The lighting module 1 can be inserted simply into a heat sink (not illustrated), for example by means of flat contact on the rear side thereof, for example by inserting into a corresponding holding fixture on the heat sink. This means that effective cooling is provided in a simple manner.

FIG. 3 shows an oblique view of the lighting module 1 with an optical element floating above as the attachment element in the form of a reflector 16. FIG. 4 shows an enlarged view of part of the lighting module with the reflector 16 floating above it in a region of the internal bayonet socket 11. The reflector 16 has a bowl-like, for example parabolically, shaped reflective inner face 17 and can be mounted with a rear-side light entry opening (not illustrated) on the or close to the light emission opening L of the light guide element 4. For fastening with the lighting module 1, the reflector 16 has a rear-side bayonet fitting 18 which engages with the internal (smaller) bayonet socket 11 of the lighting module 1. The bayonet fitting 18 has three longitudinal slots 19 and transverse slots 20 complementary to the bayonet socket, whereby a locking pin 15 is situated in the transverse slot 20. Similarly, it is also possible to mount a different attachment element having a correspondingly larger bayonet fitting and a correspondingly larger light entry opening on the external bayonet socket 12.

FIG. 5 shows an oblique view from the front of a group of light-emitting diodes 3 for use for example in the lighting module 1 in a further arrangement. The light-emitting diodes 3 are arranged in a rectangular (m×n) matrix pattern (here a square 5×5-matrix pattern).

FIG. 6 shows in a view similar to FIG. 5 a group of light-emitting diodes 3 in another arrangement. The light-emitting diodes 3 here are arranged in a pattern consisting of concentric rings with a central mounting location.

Other patterns are also possible, for example a hexagonal pattern.

FIG. 7a shows a sectional side view of the light guide element 4 surrounding the light-emitting diodes 3, with a possible light path P drawn in from one of the light-emitting diodes 3 to the light emission opening L. FIG. 7b shows an oblique view from the front of the light guide element 4. The ring-shaped cover 6 for the right-hand side is also drawn in FIG. 7a in addition to the light guide element 4.

With reference to both figures, a light-emitting diode 3 as a

Lambertian emitter typically emits essentially forwards into a front half-space which is centered around the axis of symmetry that is likewise directed forwards. One part of the light emitted by the light-emitting diodes 3 thus passes directly through the light emission opening L, while another part is reflected once or repeatedly at the reflective inner face 4a which serves as a reflective surface before it is output through the light emission opening L. The light path P drawn in represents a light beam emitted by the central light-emitting diode 3 and reflected twice at the inner face 4a.

FIG. 8 shows a sectional side view of the light guide element 4 surrounding the light-emitting diodes 3 with a plurality of possible light paths P from one of the light-emitting diodes 3, whereby the light paths P are drawn in as simple lines.

The light from the light-emitting diodes 3 is guided by means of the light guide element 4, which acts as a “light channel”, from the plane of the light-emitting diodes 3 to a higher plane of the lighting module 1, namely to the plane of the light emission opening L. This means that the mounting space required for the electronic components 30, which is represented by the surrounding region U or the volume of the ring-shaped cover, is bridged and a new, higher light emission plane is defined.

Attachment elements can then be brought as close as desired to the light emission opening L as the new light-emitting plane, which means that incoupling losses are avoided. The light-emitting diodes 3 and the further electronic components 30 can be protected. Electrically conducting attachment elements (for example aluminum reflectors) can be isolated from the electrically conducting parts on the circuit board 2 when the light guide element is designed to be electrically nonconducting, which facilitates the observance of air gaps and creepage distances.

The attachment element can in general be designed as an optical system or optical element, for example as a reflective optical system (for example as a reflector) or as a refractive optical system (for example as a lens or diffusion disk). The attachment element can also be an optically essentially non-active element, for example a transparent cover disk.

FIG. 9 shows a sectional side view of a light guide element 31 according to a further embodiment surrounding the light-emitting diodes 3, with a plurality of possible light paths.

The inner face 32 of the still essentially hollow cylindrical light guide element 31 now has a truncated conical contour with a diverging track in the upward or forward direction. This yields the advantage that the output of the light beam emitted by the light-emitting diodes 3 can be collimated, which produces a narrower angular distribution. It has proved advantageous that the angulation (also referred to as “draft angle”) a lies in a range between 1° and 10°, in particular between 1° and 5° (including the end values).

FIG. 10 shows a sectional side view of a further light guide element 33 according to another embodiment surrounding the light-emitting diodes 3, with a plurality of possible light paths. The inner face 34 of the still essentially hollow cylindrical light guide element 33 now has an inverse truncated conical contour with a converging track in the upward or forward direction. This yields the advantage that the output of the light beam emitted by the light-emitting diodes 3 can be decollimated, which produces a wider angular distribution. It has proved advantageous that the angulation a lies in a range between −1° and −10°, in particular between −1° and −5° (including the end values).

FIG. 11 again shows the light guide element 4, in an oblique view from the front. FIG. 12 shows a top view of the light guide element 4 and FIG. 13 shows a part of the light guide element 4 from FIG. 12. With reference to the three figures, light guide element 4 has on its reflective inner face 4a a surface structure in the form of a circumferential (general) wave structure. The wave structure can for example as shown have a sinusoidal wave structure, but also a form based on splines or even a free form. It has proved advantageous that a so-called “peak-to-valley” angle β of the wave structure lies in a range [30°;60°]. As a result of the surface structure a light mixture of the light output from the light-emitting diodes 3 is achieved, with regard to a brightness and/or a color.

Alternatively, other surface structures can also be used, for example in the form of a circumferential zigzag pattern.

The present invention is naturally not restricted to the exemplary embodiments shown.

The reflective surface of the light guide element, for example the inner face thereof, can thus have an optical film, for example a highly reflective mirror film or diffuser film (so-called “brightness enhancement film”, BEF), or a coating of such a type, which serves to increase efficiency.

The reflective surface of the light guide element can thus have or be a roughened surface, for example an isotropically or anisotropically scattering surface. This yields the advantage that a light mixture which is directional with respect to an azimuthal and/or polar angle can be achieved.

The reflective surface of the light guide element can also be colored in its entirety or partially in one color or multiple colors, whereby a color of the light output can be colored.

It is also possible to combine features from the different exemplary embodiments, for example a wave pattern on the inner face of the light guide element with a truncated conical shaped contour of the inner face etc., unless this has been expressly excluded.

### LIST OF REFERENCE CHARACTERS

1 Lighting module

2 Circuit board

3 Light-emitting diode

4 Light guide element

4a Inner face of light guide element

5 Front edge of light guide element

6 Ring-shaped cover

7 Screw

8 Inner wall

9 Outer wall

10 Top wall

11 Internal bayonet socket

12 External bayonet socket

13 Longitudinal slot

14 Transverse slot

15 Locking pin

16 Reflector

17 Inner face

18 Bayonet fitting

19 Longitudinal slot

20 Transverse slot

28 Connector feedthrough

29 Connector

30 Electronic components

31 Light guide element

32 Inner face of light guide element

33 Light guide element

34 Inner face of light guide element

L Light emission opening

U Surrounding region of circuit board

Z Central region of circuit board

1. A lighting module, comprising:
a circuit board equipped with at least one light source; and
a hollow light guide element which laterally surrounds the circumference of the at least one light source and extends forward beyond the at least one light source,
wherein an inner face of the light guide element is at least partially reflective and a front-side opening of the light guide element corresponds to a light emission opening of the lighting module.

2. The lighting module as claimed in claim 1, wherein a plane of the light emission opening is parallel to a plane of the at least one light-emitting diode.

3. The lighting module as claimed in claim 1, wherein the light guide element has an essentially hollow cylindrical basic form.

4. The lighting module as claimed in claim 1, wherein the light guide element comprises an electrically nonconducting material.

5. The lighting module as claimed in claim 1, having at least one receiving means for receiving an attachment element by way of the light emission opening.

6. The lighting module as claimed in claim 5, wherein the receiving means is designed as a fastening interface.

7. The lighting module as claimed in claim 1, wherein the lighting module has a cover for at least some of the electronic components disposed on the front face of the circuit board, and wherein a front face of the cover essentially lies in the plane of the light emission opening.

8. The lighting module as claimed in claim 1, wherein the light guide element is laterally surrounded at least in sections of the circumference by a ring-shaped cover for at least some of the electronic components disposed on the front face of the circuit board.

9. The lighting module as claimed in claim 1, wherein the light guide element affords a direct access to the at least one light source through the light emission opening.

10. The lighting module as claimed in claim 1, wherein the light guide element has an inner face which widens towards the front

11. The lighting module as claimed in claim 1, wherein the light guide element has an inner face which narrows towards the front.

12. The lighting module as claimed in claim 1, wherein the inner face of the light guide element has an optically active surface structure.

13. The lighting module (1) as claimed in claim 12, wherein the surface structure has a wave structure.

14. The lighting module as claimed in claim 12, wherein the surface structure has a roughened surface.

15. The lighting module as claimed in claim 1, wherein the inner face of the light guide element is colored at least in some areas.

16. The lighting module as claimed in claim 1, wherein said at least one light source is a light-emitting diode.
